(19) United States
(12) Patent Application Publication
(10) Pub. No.: US 2004/0179079 A1
(43) Pub. Date: Sep. 16, 2004

(54) Ink jet printer and ultraviolet ray irradiating device

(76) Inventor: Takeshi Yokoyama, Tokyo (JP)

Correspondence Address: CANTOR COLBURN LLP, 55 Griffin Road South, Bloomfield, CT, 06002, US

(21) Appl. No.: 10/712,817

(22) Filed: Nov. 12, 2003

(30) Foreign Application Priority Data
Nov. 20, 2002 (JP) 2002-336400

(51) Int. Cl. B41J 2/01

(52) U.S. Cl. 347/102

(57) ABSTRACT

An ink jet printer has a recording head for jetting ink to be cured by being irradiated with an ultraviolet ray from a nozzle to a recording medium and an ultraviolet ray irradiating device having a plurality of ultraviolet ray sources. The ultraviolet ray sources irradiate the ink jetted on the recording medium by the recording head with a plurality of ultraviolet rays. Each of the ultraviolet ray sources radially radiates the ultraviolet ray from a center thereof in a radiation direction, and wherein at least two ultraviolet ray sources adjacent to each other among the ultraviolet ray sources arranged adjacent to one another are arranged so as to set distances from the two ultraviolet ray sources to a recording surface of the recording medium to be different from each other.

### BACKGROUND OF THE INVENTION

1. Field of the Invention

The present invention relates to an ink jet printer and an ultraviolet ray irradiating device.

2. Description of Related Art

An ink jet printer is used to record an image on a recording medium by jetting ink from a jet port of each nozzle arranged on a recording head to the recording medium and making the ink collide with the recording medium.

As a method using the ink jet printer, there is provided a UV ink jet recording method for recording an image on a recording medium having a low ink absorption such as a resin film or the like (for example, refer to Unexamined Japanese Patent Publication (Tokukaisyou) 60-132767 (hereinafter, named “first patent document”)).

In the ink jet printer used for the UV ink jet recording method, ultraviolet curable ink (hereinafter, named “UV ink”), which includes a photochemical initiator having a predetermined sensitivity to ultraviolet rays, is generally used. When the UV ink colliding with the recording medium is irradiated with the ultraviolet rays, the UV ink is cured and fixed to the recording medium. In this case, when it takes a long time to irradiate the UV ink with the ultraviolet rays after the collision of the UV ink with the recording medium, problems are arisen that the diameter of dots of the UV ink colliding with the recording medium is enlarged, the recording medium is blurred with the UV ink between the dots, and the UV ink permeates the recording medium. Therefore, it is preferred that the period of time from the jet of the UV ink to the irradiation of the UV ink with the ultraviolet rays is set to be as short as possible.

In the ink jet printer recording an image according to a serial method disclosed in the first patent document, an ultraviolet ray irradiating device and a recording head placed close to each other are arranged on a carrier (supporting member) to be able to immediately irradiate the UV ink colliding with the recording medium with the ultraviolet rays.

The ultraviolet ray irradiating device will be described with reference to FIGS. 10A and 10B. FIG. 10A is a perspective side view schematically showing an earlier developed ultraviolet ray irradiating device 702, and FIG. 10B is a sectional view taken substantially along line F-F of FIG. 10A.

As shown in FIG. 10A, the ultraviolet ray irradiating device 702 is opened on the side of a recording medium P and has a cover member 722 formed in an almost rectangular parallelepiped shape and a plurality of ultraviolet ray sources 721 arranged at the inside of the cover member 722.

Each ultraviolet ray source 721 extends along the longitudinal direction of the cover member 722, and the ultraviolet ray sources 721 are arranged almost in line in parallel to the recording medium P so as to equalize the distances from the sources 721 to the recording medium P with one another (refer to FIG. 10B).

To cure the UV ink colliding with the recording medium P, the irradiation energy of the ultraviolet rays radiated from the ultraviolet ray sources 721 and irradiating the UV ink is required to be at least larger than the curing energy of the UV ink.

The irradiation energy is obtained by a product of an irradiation time and an irradiation strength. In a case where the irradiation strength is adjusted to be set to a predetermined value required for the curing of the UV ink, when the ultraviolet ray sources 721 are arranged in parallel to a recording surface of the recording medium P as disclosed in the first patent document, the width (hereinafter, named “radiation width”) of the ultraviolet ray sources 721 in the direction of arranging the ultraviolet ray sources 721 of the ultraviolet ray irradiating device 702 is excessively lengthened. As a result, the carrier and a printer body are undesirably enlarged.

Particularly, when the irradiation energy is desired to be further enlarged, the increase of the number of ultraviolet ray sources is required. However, a problem is arisen that the irradiation width of the ultraviolet ray irradiating device is enlarged in proportion to the number of ultraviolet ray sources.

In case of the first patent document, the irradiation time is set according to a moving speed of the carrier in a scanning direction. Therefore, when the number of ultraviolet ray sources is decreased to miniaturize the carrier, the irradiation time is required to be lengthened to enlarge the irradiation energy to a predetermined value required for the curing of the UV ink. In this case, the period of time required for the recording of the image is undesirably lengthened. Therefore, the image recording is inefficiently performed and is out of touch with reality.

Further, even in the ink jet printer recording the image according to a line method, the irradiation width in a feeding direction of the recording medium of the ultraviolet ray irradiating device is undesirably enlarged, and a problem is arisen that the printer body and the supporting member supporting both the recording head of the line method and the ultraviolet ray irradiating device are undesirably enlarged.

### SUMMARY OF THE INVENTION

In order to solve the above problem, an object of the present invention is to provide an ink jet printer and an ultraviolet ray irradiating device, in which a supporting member and a printer body can be miniaturized by miniaturizing the ultraviolet ray irradiating device.

In order to accomplish the above-mentioned object, in accordance with the first aspect of the present invention, an ink jet printer comprises:

a recording head for jetting ink to be cured by being irradiated with an ultraviolet ray from a nozzle to a recording medium; and

an ultraviolet ray irradiating device having a plurality of ultraviolet ray sources, the ultraviolet ray sources irradiating the ink jetted on the recording medium by the recording head with a plurality of ultraviolet rays,

wherein each of the ultraviolet ray sources radially radiates the ultraviolet ray from a center thereof in a radiation direction, and wherein at least two ultraviolet ray sources adjacent to each other among the ultraviolet ray sources arranged adjacent to one another are arranged so as to set distances from the two ultraviolet ray sources to a recording surface of the recording medium to be different from each other.

The ultraviolet ray has the wavelength of 180 nm to 400 nm.

In the first aspect of the present invention, at least two ultraviolet ray sources adjacent to each other among the ultraviolet ray sources arranged adjacent to one another are arranged in the ultraviolet ray irradiating device so as to set distances from the two ultraviolet ray sources to a recording surface of the recording medium to be different from each other. Therefore, when the plurality of ultraviolet ray sources are arranged in the ultraviolet ray irradiating device, the width of the ultraviolet ray irradiating device along the recording surface can be shortened as compared with another ultraviolet ray irradiating device in which a plurality of ultraviolet ray sources are arranged in line to be parallel to the recording surface. Accordingly, the ultraviolet ray irradiating device can be miniaturized. As a result, a printer body and a supporting member of a carriage and the like can be miniaturized.

At least three ultraviolet ray sources among the ultraviolet ray sources may be arranged in line so as to have a convexity in a direction going away from the recording surface.

The convexity in the direction going away from the recording surface denotes that at least three ultraviolet ray sources are arranged, for example, in an arch shape or an almost triangular shape in the longitudinal cross sectional view of the recording surface.

In this invention, the width along the recording surface of the ultraviolet ray irradiating device can be appropriately shortened, and the miniaturization of the ultraviolet ray irradiating device can be appropriately performed.

The ultraviolet ray irradiating device may further comprise a reflecting member for reflecting the ultraviolet rays radiated from the ultraviolet ray sources.

In this invention, because the ultraviolet ray irradiating device is provided with the reflecting member, the ultraviolet ray radiated from the ultraviolet ray source and not directing toward the recording medium can be reflected toward the recording medium. Accordingly, the lowering of the irradiation strength of the ultraviolet rays of the ultraviolet ray irradiating device can be prevented.

In detail, as the ultraviolet ray sources become closer to one another, the ultraviolet ray sources are stacked up in the direction perpendicular to the direction going along the recording surface. Therefore, the irradiation strength of the ultraviolet rays of the ultraviolet ray irradiating device is undesirably lowered. Particularly, when each ultraviolet ray source radially radiates the ultraviolet ray from a center thereof in a radiation direction, the irradiation strength is considerably lowered. However, the reflecting member prevents the lowering of the irradiation strength of the ultraviolet rays of the ultraviolet ray irradiating device.

Accordingly, the ultraviolet ray irradiating device can be miniaturized.

Preferably, the reflecting member is a reflecting plate made of aluminum or a glass-formed plate having a surface on which a thin film of a metallic compound including aluminum is deposited.

In this invention, aluminum efficiently reflects ultraviolet rays. Accordingly, when the reflecting member is a reflecting plate made of aluminum or a glass-formed plate having a surface on which a thin film of a metallic compound including aluminum is deposited, the ultraviolet rays radiated from the ultraviolet ray sources can be efficiently reflected toward the recording medium.

At least three ultraviolet ray sources among the ultraviolet ray sources may be arranged in line so as to have a convexity in a direction going away from the recording surface approach, and the reflecting member may be shaped to be formed along the ultraviolet ray sources.

In this invention, even though the reflecting member is shaped to be formed along the ultraviolet ray sources, the width of the ultraviolet ray irradiating device in the direction going along the recording medium can be appropriately miniaturized.

Preferably, each ultraviolet ray source is a high pressure mercury lamp, a metal halide lamp, a hot cathode tube or a cold cathode tube.

Preferably, the ink has a cationic curing property.

In this invention, the ink having the cationic curing property has a high sensitivity to the ultraviolet rays as compared with the ink having a radical curing property. Accordingly, even though the irradiation strength of the ultraviolet rays of the ultraviolet ray irradiating device is lowered by arranging the ultraviolet ray sources stacked up in the direction perpendicular to the direction going along the recording surface, the ink on the recording medium can be sufficiently cured and reliably fixed to the recording medium.

Preferably, a recording type applied to the ink jet printer is a serial type or a line type.

The serial method denotes a method in which the image recording is performed by jetting the ink from the recording head to the recording medium while reciprocally moving the recording head in the scanning direction when the feeding of the recording medium in the direction perpendicular to the scanning direction of the recording head is stopped. The line method denotes a method in which the image recording using the recording head extending in the width direction (direction perpendicular to the feeding direction of the recording medium) of the recording medium is performed while carrying the recording medium.

In this invention, when the serial type recording is used for the ink jet printer, the width in the direction going along the recording surface of the recording medium of the ultraviolet ray irradiating device, that is, the width in the scanning direction of the recording head can be shortened. When the line type recording is used for the ink jet printer, the width in the direction going along the recording surface of the recording medium of the ultraviolet ray irradiating device, that is, the width in the feeding direction of the recording medium can be shortened.

In accordance with the second aspect of the present invention, an ink jet printer comprises:

a recording head for jetting ink to be cured by being irradiated with an ultraviolet ray from a nozzle to a recording medium; and

an ultraviolet ray irradiating device having a plurality of ultraviolet ray sources, the ultraviolet ray sources irradiating the ink jetted on the recording medium by the recording head with a plurality of ultraviolet rays,

wherein each of the ultraviolet ray sources is a light emitting diode, and wherein at least two ultraviolet ray sources adjacent to each other among the ultraviolet ray sources arranged adjacent to one another are arranged so as to set distances from the two ultraviolet ray sources to a recording surface of the recording medium to be different from each other.

In the second aspect of the present invention, at least two ultraviolet ray sources adjacent to each other among the ultraviolet ray sources arranged adjacent to one another are arranged in the ultraviolet ray irradiating device so as to set distances from the two ultraviolet ray sources to a recording surface of the recording medium to be different from each other. Therefore, when the plurality of ultraviolet ray sources are arranged in the ultraviolet ray irradiating device, the width of the ultraviolet ray irradiating device along the recording surface can be shortened as compared with another ultraviolet ray irradiating device in which a plurality of ultraviolet ray sources are arranged in line to be parallel to the recording surface.

Further, even though the ultraviolet ray sources are stacked up in the direction perpendicular to the direction going along the recording surface as the ultraviolet ray sources become closer to one another, because each ultraviolet ray source is the light emitting diode radiating the ultraviolet ray having the directivity, there is little probability that the irradiation strength of the ultraviolet rays of the ultraviolet ray irradiating device is undesirably lowered.

Accordingly, the ultraviolet ray irradiating device can be miniaturized. As a result, a printer body and a supporting member of a carriage and the like can be miniaturized.

At least three ultraviolet ray sources among the ultraviolet ray sources may be arranged in line so as to have a convexity in a direction going away from the recording surface.

Preferably, the ink has a cationic curing property.

Preferably, a recording type applied to the ink jet printer is a serial type or a line type.

In accordance with the third aspect of the present invention, an ultraviolet ray irradiating device, which is arranged in an ink jet printer for jetting ink to be cured by being irradiated with an ultraviolet ray from a nozzle to a recording medium, comprises:

a plurality of ultraviolet ray sources for irradiating the ink jetted on the recording medium with a plurality of ultraviolet rays,

wherein each of the ultraviolet ray sources radially radiates the ultraviolet ray from a center thereof in a radiation direction, and wherein at least two ultraviolet ray sources adjacent to each other among the ultraviolet ray sources arranged adjacent to one another are arranged so as to set distances from the two ultraviolet ray sources to a recording surface of the recording medium to be different from each other.

In the third aspect of the present invention, at least two ultraviolet ray sources adjacent to each other among the ultraviolet ray sources arranged adjacent to one another are arranged so as to set distances from the two ultraviolet ray sources to a recording surface of the recording medium to be different from each other. Therefore, when the plurality of ultraviolet ray sources are arranged in the ultraviolet ray irradiating device, the width of the ultraviolet ray irradiating device along the recording surface can be shortened as compared with another ultraviolet ray irradiating device in which a plurality of ultraviolet ray sources are arranged in line to be parallel to the recording surface. Accordingly, the ultraviolet ray irradiating device can be miniaturized. As a result, a printer body and a supporting member of a carriage and the like can be miniaturized.

At least three ultraviolet ray sources among the ultraviolet ray sources may be arranged in line so as to have a convexity in a direction going away from the recording surface.

The ultraviolet ray irradiating device may further comprise a reflecting member for reflecting the ultraviolet rays radiated from the ultraviolet ray sources.

Preferably, the reflecting member is a reflecting plate made of aluminum or a glass-formed plate having a surface on which a thin film of a metallic compound including aluminum is deposited.

At least three ultraviolet ray sources among the ultraviolet ray sources may be arranged in line so as to have a convexity in a direction going away from the recording surface approach, and the reflecting member may be shaped to be formed along the ultraviolet ray sources.

Preferably, each ultraviolet ray source is a high pressure mercury lamp, a metal halide lamp, a hot cathode tube or a cold cathode tube.

In accordance with the fourth aspect of the present invention, an ultraviolet ray irradiating device, which is arranged in an ink jet printer for jetting ink to be cured by being irradiated with an ultraviolet ray from a nozzle to a recording medium, comprises:

a plurality of ultraviolet ray sources for irradiating the ink jetted on the recording medium with a plurality of ultraviolet rays,

wherein each of the ultraviolet ray sources is a light emitting diode, and wherein at least two ultraviolet ray sources adjacent to each other among the ultraviolet ray sources arranged adjacent to one another are arranged so as to set distances from the two ultraviolet ray sources to a recording surface of the recording medium to be different from each other.

In the fourth aspect of the present invention, at least two ultraviolet ray sources adjacent to each other among the ultraviolet ray sources arranged adjacent to one another are arranged so as to set distances from the two ultraviolet ray sources to a recording surface of the recording medium to be different from each other. Therefore, when the plurality of ultraviolet ray sources are arranged in the ultraviolet ray irradiating device, the width of the ultraviolet ray irradiating device along the recording surface can be shortened as compared with another ultraviolet ray irradiating device in which a plurality of ultraviolet ray sources are arranged in line to be parallel to the recording surface.

Further, even though the ultraviolet ray sources are stacked up in the direction perpendicular to the direction going along the recording surface as the ultraviolet ray sources become closer to one another, because each ultraviolet ray source is the light emitting diode radiating the ultraviolet ray having the directivity, there is little probability that the irradiation strength of the ultraviolet rays of the ultraviolet ray irradiating device is undesirably lowered.

Accordingly, the ultraviolet ray irradiating device can be miniaturized. As a result, a printer body and a supporting member of a carriage and the like can be miniaturized.

At least three ultraviolet ray sources among the ultraviolet ray sources may be arranged in line so as to have a convexity in a direction going away from the recording surface.

### BRIEF DESCRIPTION OF THE DRAWINGS

The present invention will become more fully understood from the detailed description given hereinbelow and the accompanying drawing which are given by way of illustration only, and thus are not intended as a definition of the limits of the present invention, and wherein;

FIG. 1 is a perspective side view showing the configuration of a main portion of an ink jet printer according to the first embodiment of the present invention;

FIG. 2A is a perspective side view showing a carriage of the ink jet printer of FIG. 1 seen from the same direction as that in FIG. 1, and FIG. 2B is a perspective side view showing the carriage seen in the inclined upper direction from the lower right in FIG. 1;

FIG. 3A is a perspective side view showing a ultraviolet ray irradiating device of the carriage shown in FIG. 2A, and FIG. 3B is a sectional view of the ultraviolet ray irradiating device shown in FIG. 3A and a sectional view of an earlier developed ultraviolet ray irradiating device;

FIG. 4A is a perspective side view schematically showing an ultraviolet ray irradiating device of the ink jet printer according to the second embodiment of the present invention, and FIG. 4B is a sectional view taken substantially along line B-B of FIG. 4A;

FIG. 5 is a perspective side view showing a head of the ink jet printer according to the third embodiment of the present invention;

FIG. 6A is a perspective side view schematically showing an ultraviolet ray irradiating device of the first modification, and FIG. 6B is a sectional view taken substantially along line C-C of FIG. 6A;

FIG. 7A is a perspective side view schematically showing an ultraviolet ray irradiating device of the second modification, and FIG. 7B is a sectional view taken substantially along line D-D of FIG. 7A;

FIG. 8A is a perspective side view schematically showing an ultraviolet ray irradiating device of the third modification, and FIG. 8B is a sectional view taken substantially along line E-E of FIG. 8A;

FIG. 9 is a perspective side view schematically showing a ultraviolet ray irradiating device having modified ultraviolet ray sources; and

FIG. 10A is a perspective side view schematically showing an earlier developed ultraviolet ray irradiating device, and FIG. 10B is a sectional view taken substantially along line F-F of FIG. 10A.

### PREFERRED EMBODIMENTS OF THE INVENTION

Hereinafter, embodiments of the present invention will be explained with reference to the drawings. The scope of the invention is not limited to the embodiments or drawings.

First Embodiment:

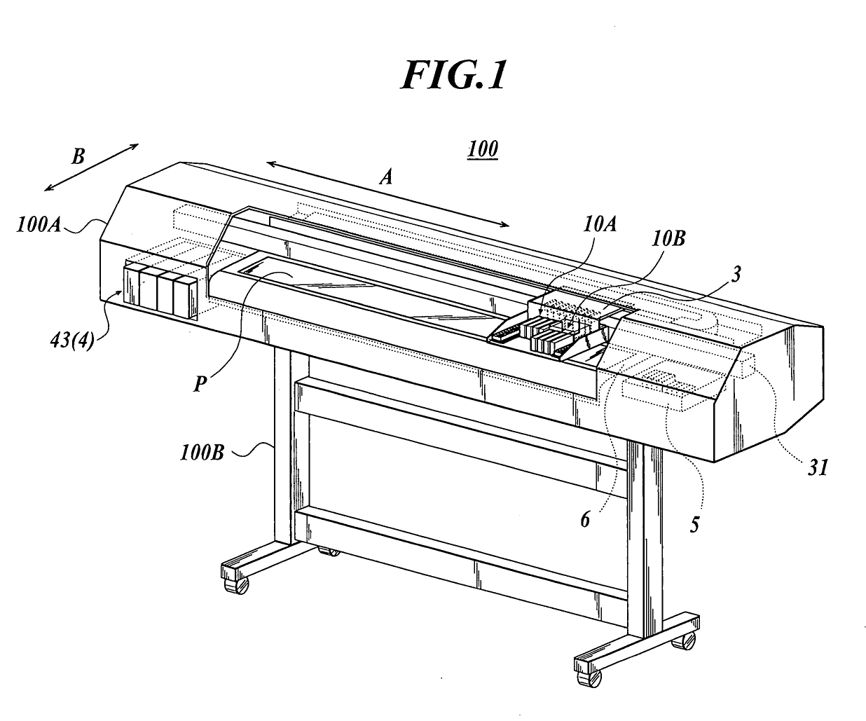

FIG. 1 is a perspective side view showing the configuration of a main portion of an ink jet printer according to the first embodiment of the present invention.

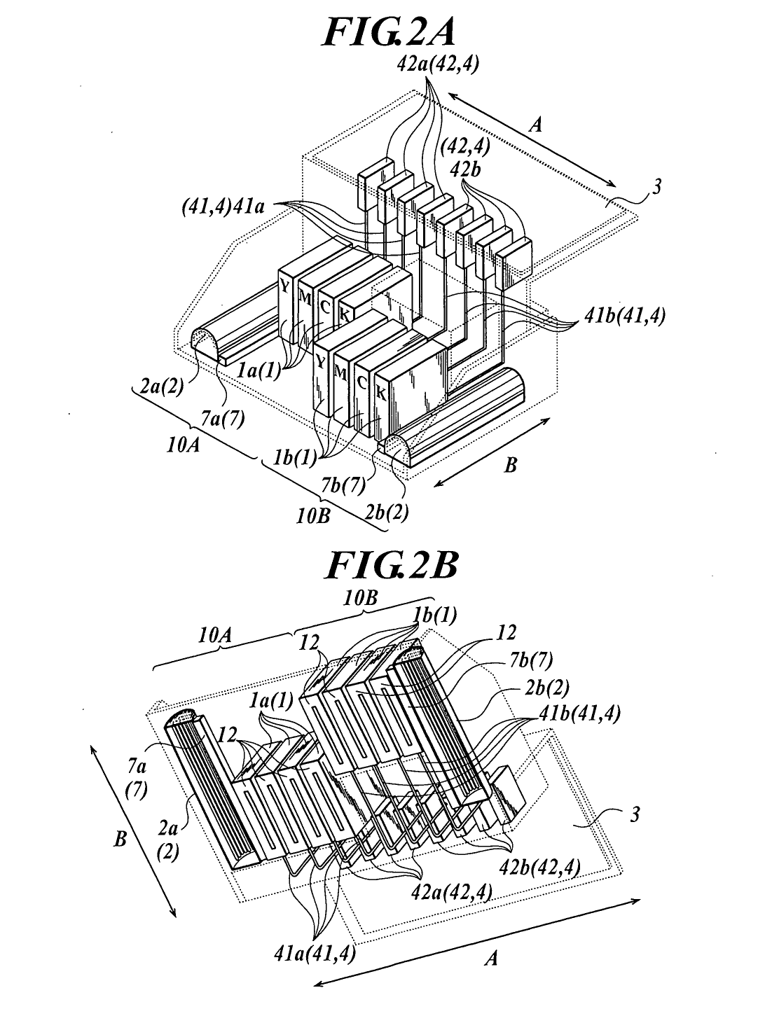

As shown in FIG. 1, an ink jet printer 100 comprises a printer body 100A and a supporting stand 100B for supporting the printer body 100A. The printer body 100A comprises a first image recording unit 10A and a second image recording unit 10B, a carriage 3, an ink supply unit 4, a maintenance unit 5, a platen 6 and a feeding mechanism (not shown). Each of the units 10A and 10B has a plurality of recording heads 1 (refer to FIG. 2A) and an ultraviolet ray irradiating device 2 (ultraviolet ray irradiating unit, refer to FIG. 2A).

The ink jet printer 100 is used to record the image according to the serial method in which the image is formed by jetting ink from each recording head 1 to the recording medium P, of which the feeding in a direction (hereinafter, named “sub-scanning direction B”) perpendicular to a main scanning direction A of the recording head 1 is stopped, while reciprocating the recording head 1 in the main scanning direction A.

The feeding mechanism, for example, has a feeding motor and a feeding roller not shown. The recording medium P is fed in the sub-scanning direction B by rotating the feeding roller by the driving of the feeding motor. Further the feeding mechanism intermittently feeds the recording medium P by repeating the feeding and stop of the recording medium P in synchronization with the movement of the carriage 3.

The “recording medium P” used in this embodiment will be described.

As the recording medium P used in this embodiment, various types papers applied to the normal ink jet printer such as a plain paper, a recycled paper, a glossy paper and the like, and record media made of materials such as various types clothes, various types nonwoven fabrics, resin, metal, glass and the like can be applied. Further the record media formed in a roll shape, a cut sheet shape, a plate shape and the like can be applied to the recording medium P.

Particularly, a made-of-resin film having the transparent or opaque and non-absorptive property and used for so-called flexible packaging can be applied as the recording medium P used in this embodiment. As types of resin used for the made-of-resin film, polyethyleneterephthalate, polyester, polyolefin, polyamide, polyesteramide, polyether, polyimide, polyamideimide, polystyrene, polycarbonate, poly-ρ-phenylenesulfide, polyetherester, polyvinyl chloride, poly(meta)acrylicester, polyethylene, polypropylene, nylon and the like can be applied. Further, co-polymer of those resins, mixture of those resins, bridge formation of those resins and the like can be applied as the resin used for the made-of-resin film. Among of those resins, when transparency, size stability, rigidity, environmental burden, cost and the like in the film made of resin are considered, any of the extended polyethyleneterephthalate, polystyrene, polypropylene and nylon is preferred as the type of resin used for the made-of-resin film. Further the made-of-resin film having the thickness of 2 micro-meters (μm) or more and 100 μm or less (preferably, 6 μm or more and 50 μm or less) is preferred. Further surface treatment such as corona jet treatment, adhesion-adding treatment or the like may be performed for the surface of a supporting member of the made-of-resin film.

Moreover, known opaque record media such as various papers of which the surfaces are coated with resin, a film including pigment, a foam film and the like can be applied as the recording medium P used in this embodiment.

The platen 6 is arranged almost horizontally and attracts and supports a predetermined area of the lower surface (denoting the reverse surface to the recording surface) of the recording medium P on the upper surface of the platen 6 by the driving of a suction means (not shown).

The carriage 3 is arranged over the platen 6.

Next, the carriage 3 will be described in detail with reference to FIGS. 2A and 2B.

FIG. 2A is a perspective side view showing the carriage 3 seen from the same direction as that in FIG. 1, and FIG. 2B is a perspective side view showing the carriage 3 seen in the inclined upper direction from the lower right in FIG. 1. The carriage 3 is shown by the broken line in FIGS. 2A and 2B to indicate the state of the carriage 3 seen through the printer body 100A.

As shown in FIG. 2A, the carriage 3 contains the first image recording unit 10A and the second image recording unit 10B and is movable in the main scanning direction A while being led by a carriage rail 31 (refer to FIG. 1) extending along the main scanning direction A.

The moving direction of the carriage 3 is changed according to the rotational direction of a driving source (not shown), so that the carriage 3 is reciprocated in the main scanning direction A. In case of the image recording, when the recording medium P is stopped, the carriage 3 is moved forward by one way or is moved backward or is reciprocated in the main scanning direction A. At this time, the image is recorded on the recording medium P by the first and second image recording units 10A and 10B.

The first image recording unit 10A is arranged on the back left side of the carriage 3 shown in FIGS. 2A and 2B and performs the image recording when the carriage 3 is moved to the right along the main scanning direction A.

The second image recording unit 10B is arranged on the frontal right side of the carriage 3 shown in FIGS. 2A and 2B and performs the image recording when the carriage 3 is moved to the left along the main scanning direction A.

Each of the first and second image recording units 10A and 10B contains the set of recording heads 1 (1a or 1b), the ultraviolet ray irradiating device 2 (2a or 2b), a light trap 7 (7a or 7b) and an intermediate tank 42 (42a or 42b).

Each set of the recording heads 1a and 1b is composed of four heads corresponding to four ink colors (yellow (Y), magenta (M), cyan (C) and black (K)) used in the ink jet printer 100.

Each recording head 1 is arranged so as to make a lower surface 12 (hereinafter, named “nozzle surface 12”, and refer to FIG. 2B) of the recording head 1 be opposite to the recording surface (upper surface) of the recording medium P fed on the platen 6. A plurality of jet ports of nozzles (not shown) are formed on the nozzle surface 12 of each recording head 1, and the jet ports are arranged in line (nozzle string) in the sub-scanning direction B. Further each recording head 1 has a jetting means (not shown) such as a piezo element (piezoelectric element), and a drop of ink is jetted from each jetting port by the driving of the jetting means.

Ink supplied to each recording head 1 is led from the intermediate tank 42 holding the ink through an ink supply tube 41 (41a or 41b). The recording heads 1 in each of the first and second image recording units 10A and 10B correspond to the four intermediate tanks 42 and the four ink supply tubes 41 respectively.

The ink held in each intermediate tank 42 is thereby supplied to the corresponding recording head 1.

The “ink” used in this embodiment will be described hereinafter.

Ink conforming to conditions described in “Curing System Using Optical Acid Radical-Base Generating Agent (first section)” or “Light-Induced Alternate Copolymer (second section)” of “Photo-Curing System (fourth chapter)” of “Photo-Curing Technique—Selection of Resin and Initiator Agent and Measurement and Estimation of Mixing Condition and Cure—(Information of Technical Association)” or the like can be particularly applied as the ink used in this embodiment, and ink cured by the normal radical polymerization may be used.

In detail, the ink used in this embodiment is ultraviolet ray curable ink having a property cured by the irradiation with ultraviolet rays representing light and includes at least a polymerizing compound (including the known polymerizing compound), a photochemical initiator and a color material as main components. However, when the ink conforming to conditions described in “Light-Induced Alternate Copolymer (second section)” is used as the ink used in this embodiment, the photochemical initiator may be omitted.

The ultraviolet ray curable ink is classified into a radical polymerization type ink including a radical polymerizing compound and cationic polymerization type ink including a cationic polymerizing compound. Both types ink cal be applied as the ink used in this embodiment, and a hybrid type ink obtained by the combination of the radical polymerization type ink and the cationic polymerization type ink may be applied as the ink used in this embodiment.

However, because the cationic polymerization type ink hardly or not damaged by the polymerization based on oxygen is excellent functionally and widely in use, the cationic polymerization type ink is used in this embodiment.

The cationic polymerization type ink used in this embodiment is the mixture including at least a cationic polymerizing compound such as an oxetane compound, an epoxy compound, a vinyl ether compound or the like, a photochemical cationic initiator and a color material, and the type of ink has a property cured by the irradiation with the ultraviolet rays.

One ultraviolet ray irradiating device 2 is arranged in each of the first and second image recording units 10A and 10B, and the devices 2 are respectively placed on both ends of the carriage 3 along the main scanning direction A. That is, the ultraviolet ray irradiating device 2a of the first image recording unit 10A is placed on the back left end in FIGS. 2A and 2B, and the ultraviolet ray irradiating device 2b of the second image recording unit 10B is placed on the frontal right end in FIGS. 2A and 2B.

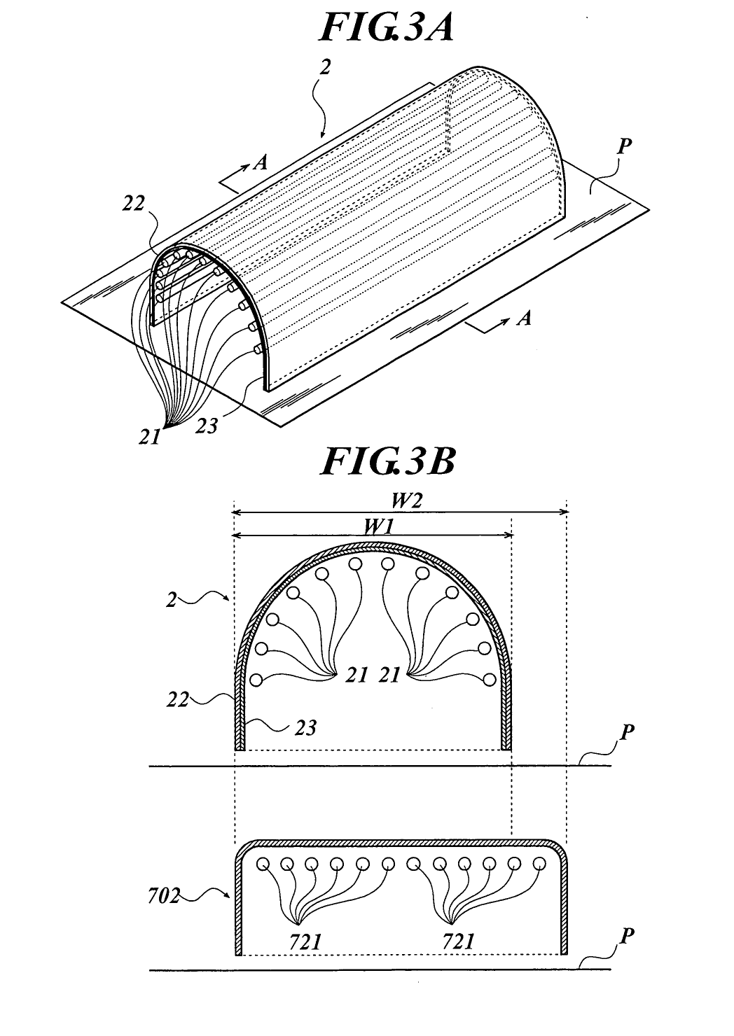

The ultraviolet ray irradiating device 2 will be described in more detail with reference to FIGS. 3A and 3B.

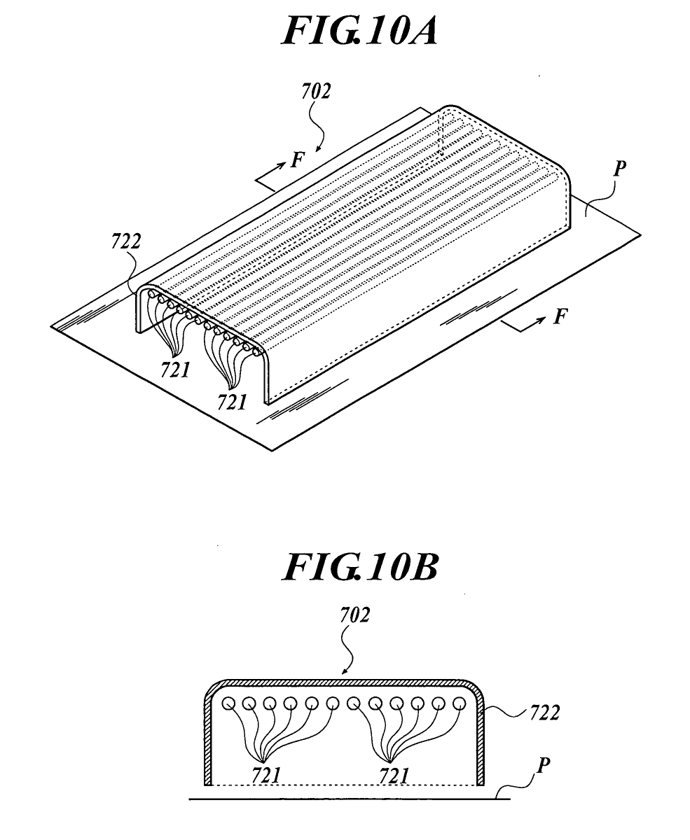

FIG. 3A is a perspective side view showing the ultraviolet ray irradiating device 2, FIG. 3B is a sectional view taken substantially along A-A line of FIG. 3A and a sectional view of the earlier developed ultraviolet ray irradiating device 702 taken substantially along F-F line of FIG. 10.

As shown in FIG. 3A, the ultraviolet ray irradiating device 2 is arranged opposite to the recording plane of the recording medium P.

The ultraviolet ray irradiating device 2 comprises a plurality of ultraviolet ray sources 21, - - - , a cover member 22 with which the ultraviolet ray sources 21, - - - are covered, and a reflecting member 23, shaped to be formed along the ultraviolet ray sources 21, - - - , for reflecting the ultraviolet rays radiated from the ultraviolet ray sources 21, - - - .

The cover member 22 is a member formed in a concave shape so as to be opened toward the side of the recording medium P, and the ultraviolet ray sources 21, - - - are covered with the cover member 22 placed on the sides of the sources 21, - - - opposite to the recording medium P through the sources 21, - - - . The reflecting member 23 is arranged on the inner circumferential surface of the cover member 22.

The reflecting member 23 reflects ultraviolet rays toward the recording medium P when the ultraviolet rays are radiated from the ultraviolet ray sources 21, - - - and are particularly directed to directions different from that of the recording medium P. That is, the reflecting member 23 is shaped so as to concentrate the ultraviolet rays on the recording surface of the recording medium P by reflecting the ultraviolet rays incident on the reflecting member 23.

A reflecting plate made of high-purity aluminum efficiently reflecting ultraviolet rays in a band of all wavelengths of the ultraviolet rays is, for example, applied as the reflecting member 23. Preferably, a cold mirror (glass-formed plate) obtained by depositing a thin film of a metallic compound mainly including aluminum on the surface of glass is applied as the reflecting member 23. Particularly, because the cold mirror efficiently reflects the ultraviolet rays and transmits visible rays and infrared rays not contributing to the curing of ink to the back side of the cold mirror, the cold mirror can suppress the lowering of a light emitting efficiency of the ultraviolet ray sources 21, - - - based on the heating-up of the sources 21, - - - .

The plurality of ultraviolet ray sources 21, - - - are arranged on the side of the reflecting member 23 facing the recording medium P.

Each ultraviolet ray source 21 is a light source formed in a line shape extending in the sub-scanning direction B, and the length of the ultraviolet ray source 21 is longer than that of the nozzle string of the recording head 1.

Further each ultraviolet ray source 21 is a light source radially radiating ultraviolet rays having the wavelength of 180 nm to 400 nm from the center of the source 21. At least one type selected from a type of high pressure mercury lamps, a type of metal halide lamps, a type of hot cathode tubes and a type of cold cathode tubes is applied as the ultraviolet ray source 21.

The ultraviolet ray sources 21, - - - are arranged along the inner surface of the reflecting member 23 (refer to FIG. 3B). That is, the ultraviolet ray sources 21, - - - are arranged in line in an arch shape in the longitudinal cross sectional view of the recording surface of the recording medium P so as to have a convexity in a direction going away from the recording surface. In detail, the ultraviolet ray sources 21, - - - are arranged on condition that at least two ultraviolet ray sources 21, 21 adjacent to each other among the ultraviolet ray sources 21, - - - arranged adjacent to one another are placed so as to set heights (distances from the two sources 21, 21 to the recording medium P) of the two sources 21, 21 from the recording surface of the recording medium P to be different from each other. Therefore, the center axes of the two ultraviolet ray sources 21, 21 adjacent to each other become closer to each other in the main scanning direction A (the direction going along the recording surface of the recording medium P).

Accordingly, as shown in FIG. 3B, as compared with a width W2 of the ultraviolet ray irradiating device 702, in which the ultraviolet ray sources 721 are arranged in a line to be parallel to the recording surface, along the main scanning direction A, a width W1 of the ultraviolet ray irradiating device 2 along the main scanning direction A can be shortened without decreasing the number of ultraviolet ray sources 21, - - - , that is, while maintaining the irradiation energy of the ultraviolet ray irradiating device 2 to a predetermined value.

The light trap 7 is arranged between each ultraviolet ray irradiating device 2 and one recording head 1, for example, corresponding to the black (K) ink and adjacent to the ultraviolet ray irradiating device 2 to trap the ultraviolet rays incident on the recording head 1.

The ink supplying unit 4 comprises a plurality of ink tanks 43 holding the kinds of ink respectively and a plurality of ink supply paths 44 leading the kinds of ink of the ink tanks 43 to the intermediate tanks 42 respectively, in addition to the ink supply tubes 41 and the intermediate tanks 42.

The ink tanks 43 are arranged to be adjacent to the platen 6 along the main scanning direction A, and the number of ink tanks 43 is four corresponding to the four colors of the kinds of ink used in the ink jet printer 100.

The maintenance unit 5 is arranged on one end of the moving area of the carriage 3 so as to place the platen 6 between the maintenance unit 5 and the ink tanks 43 and performs the work of maintaining the recording heads 1.

As described above, in the ink jet printer 100 of the first embodiment, the image recording is performed according to the serial method, and the carriage 3 can be miniaturized by shortening the width W1 of the ultraviolet ray irradiating device 2 along the main scanning direction A. That is, as shown in FIGS. 2A and 2B, the height of each recording head 1 is considerably higher than that of the ultraviolet ray irradiating device 2 in the carriage 3. Therefore, even though the height of the ultraviolet ray irradiating device 2 is heightened in some degree, the height of the ultraviolet ray irradiating device 2 does not influence on the size of the whole carriage 3. In contrast, the carriage 3 can be miniaturized by shortening the width W1 of the ultraviolet ray irradiating device 2 along the main scanning direction A.

Further, the ultraviolet rays, which are radiated from the ultraviolet ray sources 21, - - - and are directed to directions different from that to the recording medium P, are reflected by the reflecting member 23 of the ultraviolet ray irradiating device 2 to be directed toward the recording medium P. Accordingly, the lowering of the irradiation strength of the ultraviolet rays radiated from the ultraviolet ray irradiating device 2 can be prevented.

Therefore, the carriage 3 can be miniaturized while maintaining the irradiation energy to the predetermined value required for the curing of the ink of the recording medium P. As a result, the ink jet printer body 100 can be miniaturized.

Moreover, the cationic curable ink having high sensitivity to the ultraviolet rays is used. Accordingly, even though the ink is irradiated with a small amount of ultraviolet rays, the ink placed on the recording medium P can be sufficiently cured as compared with the radical curable ink, and the ink can be tightly fixed to the recording medium P.

Further more, even though the ultraviolet ray irradiating device 2 is provided with one type selected from the type of high pressure mercury lamps, the type of metal halide lamps, the type of hot cathode tubes and the type of cold cathode tubes, the ultraviolet ray irradiating device 2 can be miniaturized.

Second Embodiment:

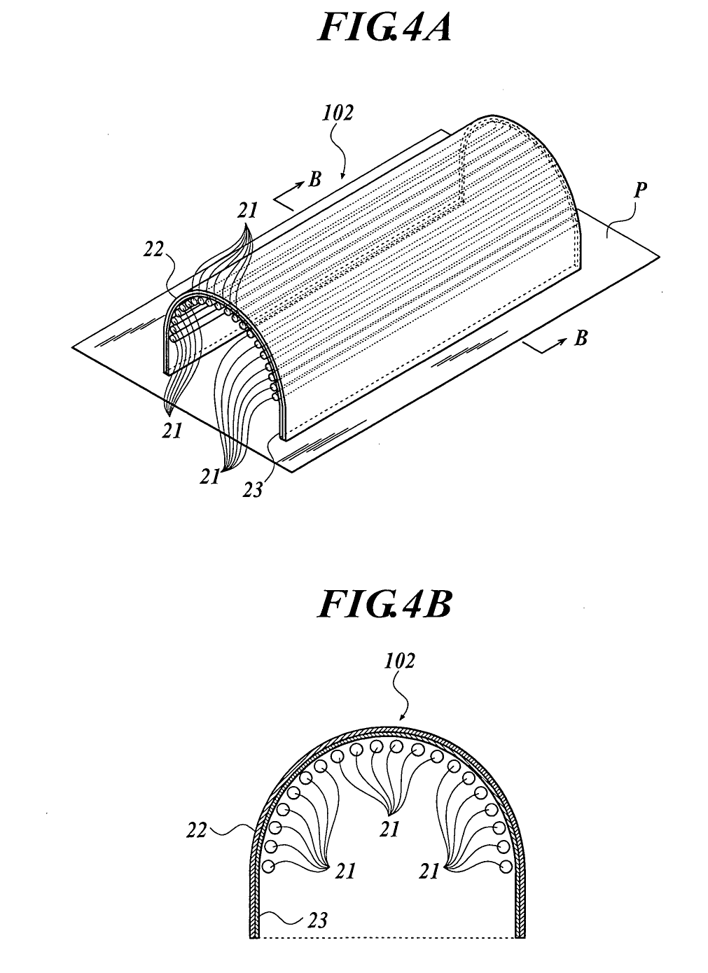

Hereinafter, an ink jet printer according to the second embodiment of the present invention will be described with reference to FIGS. 4A and 4B.

In the second embodiment, functions and configuration other than those peculiar to the second embodiment are the same as those of the first embodiment. Therefore, the same constituent elements as those of the first embodiment are indicated by the same referential numerals as those of the first embodiment, and the description of the constituent elements is omitted.

FIG. 4A is a perspective side view schematically showing an ultraviolet ray irradiating device 102 of the ink jet printer according to the second embodiment, and FIG. 4B is a sectional view taken substantially along line B-B of FIG. 4A.

As shown in FIGS. 4A and 4B, in the ink jet printer of the second embodiment, the ultraviolet ray irradiating device 102 is provided with the plurality of ultraviolet ray sources 21, - - - of which the number (for example, twenty) is larger than that in the first embodiment.

In this case, the width of the ultraviolet ray irradiating device 702 along the main scanning direction A is widened in proportional to the number of ultraviolet ray sources 721 in the earlier development when the string of the ultraviolet ray sources 721 is parallel to the recording surface of the recording medium P in the ultraviolet ray irradiating device 702 (refer to FIG. 3B). However, in the second embodiment, the width of the ultraviolet ray irradiating device 102 along the main scanning direction A is not widened in proportional to the number of ultraviolet ray sources 21, - - - even though the number of ultraviolet ray sources 21, - - - is increased. Accordingly, the carriage 3 and the ink jet printer can be miniaturized.

Further, the irradiation energy can be heightened by increasing the number of ultraviolet ray sources 21, - - - . Therefore, even though the irradiation time is shortened, the irradiation energy can be maintained to the prescribed value required for the curing of the ink of the recording medium P. Accordingly, the time required for the image recording can be shortened, and the image recording can be further efficiently performed.

In the first and second embodiments, the first image recording unit 10A and the second image recording unit 10B are provided with the ultraviolet ray irradiating device 2 or 102. However, each of the embodiments is not limited to the arrangement of each device 2 or 102. For example, each of the ultraviolet ray irradiating devices 2 and 102 may be arranged between the group of recording heads 1a of the first image recording unit 10A and the group of recording heads 1b of the second image recording unit 10B adjacent to each other in the configuration shown in FIGS. 2A and 2B.

Third Embodiment:

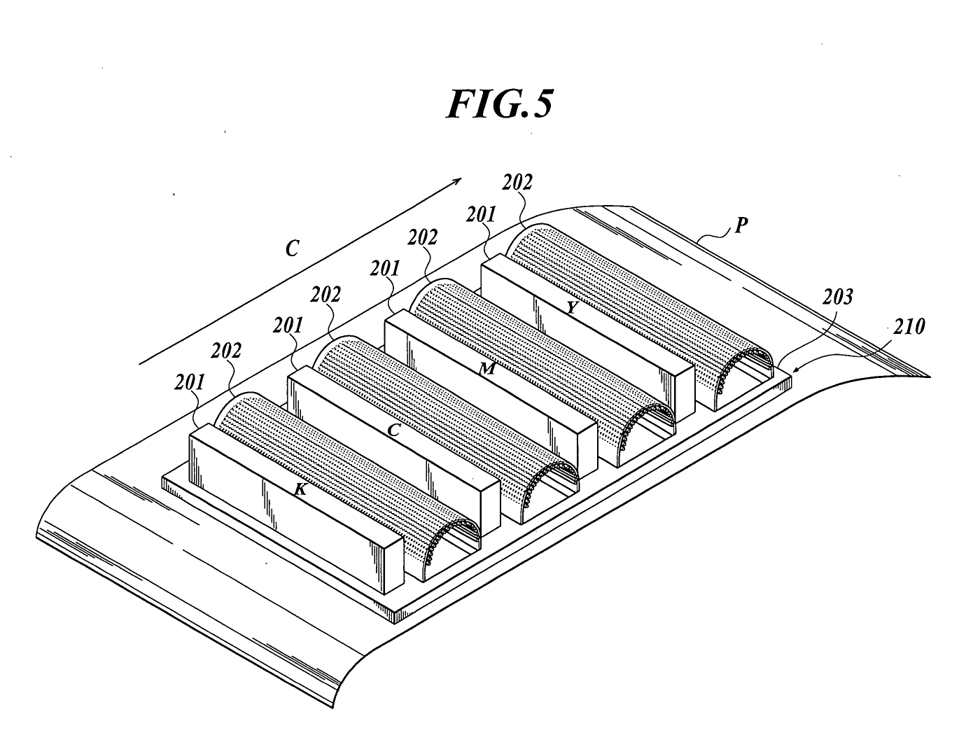

Hereinafter, an ink jet printer according to the third embodiment of the present invention will be described with reference to FIG. 5.

In the third embodiment, functions and configuration other than those peculiar to the third embodiment are the same as those of the first or second embodiment. Therefore, the same constituent elements as those of the first or second embodiment are indicated by the same referential numerals as those of the first or second embodiment, and the description of the constituent elements is omitted.

FIG. 5 is a perspective side view showing a head unit 210 of the ink jet printer according to the third embodiment.

The ink jet printer according to the third embodiment is provided with a plurality of line heads 201, which each extend in the width direction (direction perpendicular to the feeding direction C of the recording medium P) of the recording medium P, to perform the image recording according to the line method forming the image by feeding the recording medium P.

That is, as shown in FIG. 5, the ink jet printer of the third embodiment comprises the head unit 210 comprising the line heads 201, a plurality of ultraviolet ray irradiating devices 202 and a supporting member 203.

The number of line heads 201 is four, and the line heads 201 are arranged along the feeding direction C of the recording medium P so as to make the longitudinal directions of the line heads 201 be parallel to one another.

The number of ultraviolet ray irradiating devices 202 is four, and each ultraviolet ray irradiating device 202 is placed on the downstream side of the corresponding line head 201 in the feeding direction C of the recording medium P.

The length of each ultraviolet ray irradiating device 202 in the same direction as the longitudinal direction of the corresponding line head 201 is longer than that of the nozzle string of the line head 201.

The supporting member 203 supports the line heads 201 and the ultraviolet ray irradiating devices 202 mounted thereon. The supporting member 203 is fixed to the ink jet printer through a fixing member (not shown) so as to set the heights of the line heads 201 and the ultraviolet ray irradiating devices 202 from the recording surface of the recording medium P to a constant value.

Even in the configuration of the head unit 210 described above, when the ultraviolet ray sources 21, - - - having different heights from the recording surface are arranged in each ultraviolet ray irradiating device 202, the ultraviolet ray irradiating device 202 can be miniaturized, and the whole head unit 210 can be miniaturized. Accordingly, the printer body can be miniaturized even in the ink jet printer 100 which performs the image recording according to the line method.

<Modifications of the Ultraviolet Ray Irradiating Device>

Hereinafter, modifications of the ultraviolet ray irradiating device will be described with reference to drawings.

In these modifications, functions and configuration of each modification other than those peculiar to the modification are the same as those of the first, second or third embodiment. Therefore, the same constituent elements as those of the first, second or third embodiment are indicated by the same referential numerals as those of the first, second or third embodiment, and the description of the constituent elements is omitted.

<First Modification>

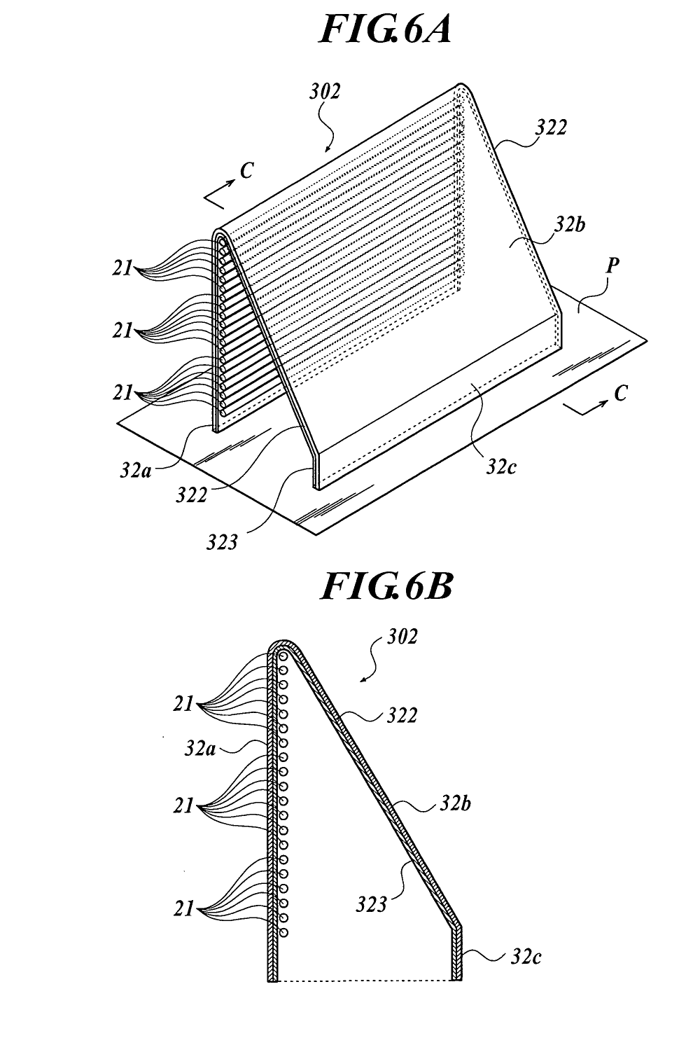

FIG. 6A is a perspective side view schematically showing an ultraviolet ray irradiating device 302 of the first modification, and FIG. 6B is a sectional view taken substantially along line C-C of FIG. 6A.

As shown in FIGS. 6A and 6B, a cover member 322 of the ultraviolet ray irradiating device 302 comprises a wide surface 32a formed and extending almost in perpendicular to the recording surface of the recording medium P, an inclined surface 32b formed and extending from the end of the wide surface 32a away from the recording surface to the recording surface while inclining against the recording surface, and a sandwiched surface 32c formed and extending from the end of the inclined surface 32b placed on the side of the recording surface to the recording surface of the recording medium P almost in perpendicular to the recording surface.

A reflecting member 323 is arranged on the inner surface of the cover member 322, and the ultraviolet ray sources 21, - - - are arranged in line in the direction almost perpendicular to the recording surface along a partial area of the reflecting member 323 arranged on the wide surface 32a.

<Second Modification>

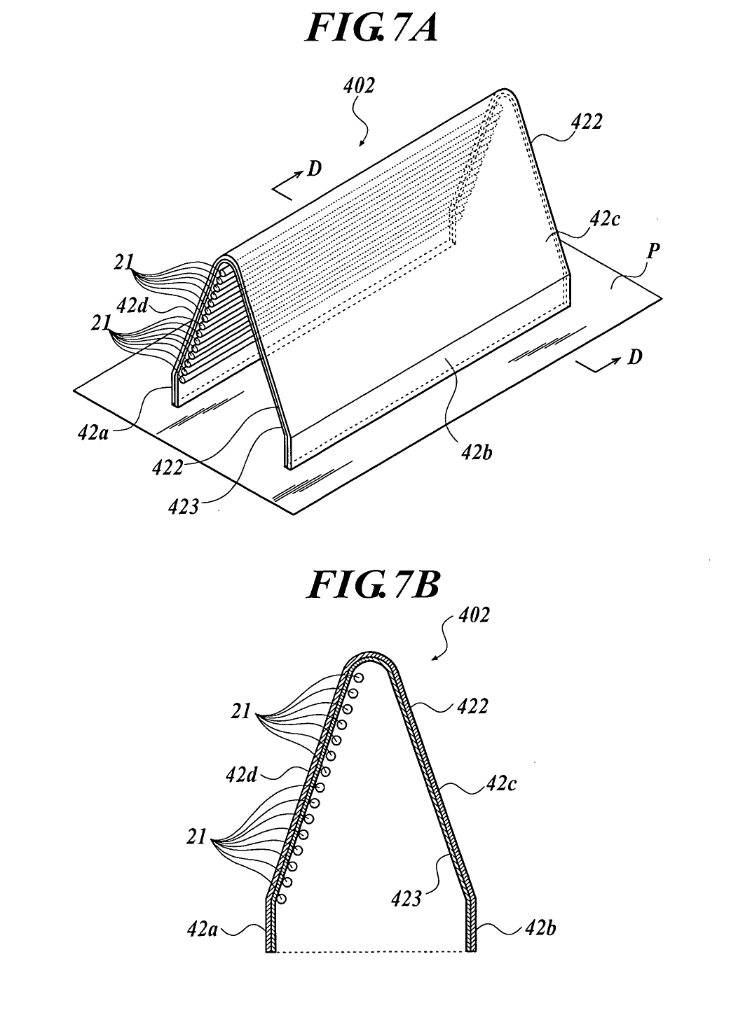

FIG. 7A is a perspective side view schematically showing an ultraviolet ray irradiating device 402 of the second modification, and FIG. 7B is a sectional view taken substantially along line D-D of FIG. 7A.

As shown in FIGS. 7A and 7B, a cover member 422 of the ultraviolet ray irradiating device 402 comprises two perpendicular surfaces 42a and 42b formed and extending almost in perpendicular to the recording surface of the recording medium P and set to the almost same height as each other, and a right inclined surface 42c and a left inclined surface 42d formed and extending from the upper ends of the perpendicular surfaces 42a and 42b respectively while being inclined toward the inside at the same angle as each other.

A reflecting member 423 is arranged on the inner surface of the cover member 422, and the plurality of ultraviolet ray sources 21, - - - are arranged in line in the upper direction going along a partial area of the reflecting member 423 arranged on the left inclined surface 42d. <

Third Modification>

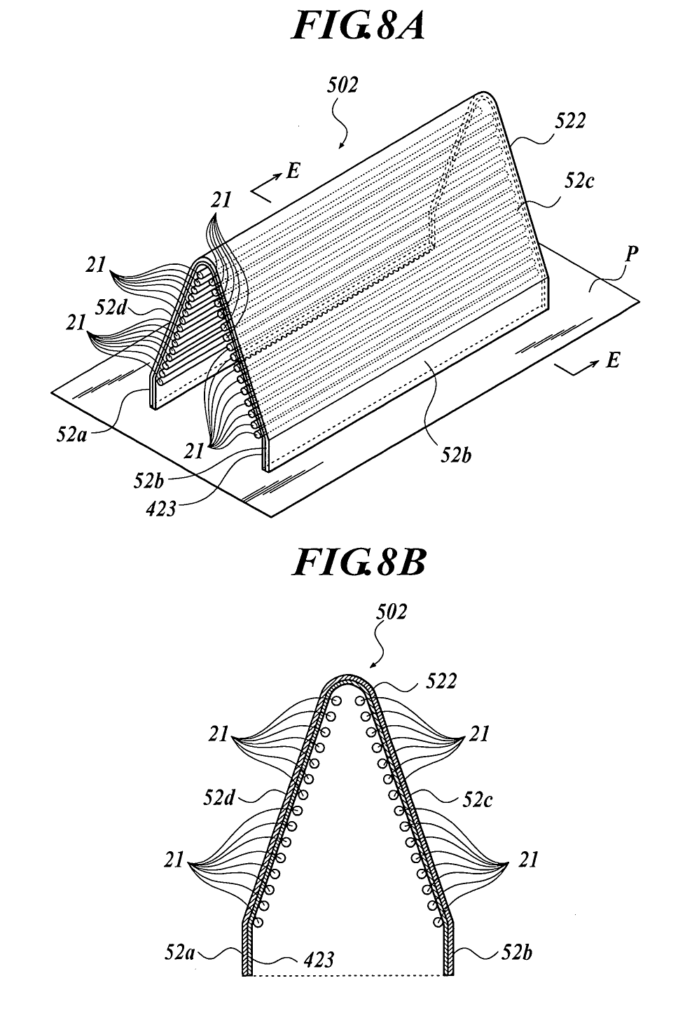

FIG. 8A is a perspective side view schematically showing an ultraviolet ray irradiating device 502 of the third modification, and FIG. 8B is a sectional view taken substantially along line E-E of FIG. 8A.

As shown in FIGS. 8A and 8B, in the same manner as in the ultraviolet ray irradiating device 402, a cover member 522 of the ultraviolet ray irradiating device 502 comprises two perpendicular surfaces 52a and 52b formed and extending almost in perpendicular to the recording surface of the recording medium P and set to the almost same height as each other, and a right inclined surface 52c and a left inclined surface 52d formed and extending from the upper ends of the perpendicular surfaces 52a and 52b respectively while being inclined toward the inside at the same angle as each other.

The reflecting member 423 is arranged on the inner surface of the cover member 522, and the ultraviolet ray sources 21, - - - are arranged in line in the upper direction going along the reflecting member 423 arranged on the right inclined surface 52c and the left inclined surface 52d. That is, the ultraviolet ray sources 21, - - - are arranged in an almost triangular shape in the longitudinal cross sectional view of the recording surface of the recording medium P so as to have a convexity in a direction going away from the recording surface.

In the first to third modifications, the lengths of the ultraviolet ray irradiating devices 302, 402 and 502 are at least longer than that of the nozzle string of the recording head 1. The ultraviolet ray irradiating devices 302, 402 and 502 are arranged opposite to the recording surface of the recording medium P so as to make the ends of the ultraviolet ray irradiating devices 302, 402 and 502 on the side of the recording medium P be parallel to the recording surface.

Further, in the first to third modifications, a vertex portion at the upper end of each of the ultraviolet ray irradiating devices 302, 402 and 502 shown in FIGS. 6B, 7B and 8B is formed in a bow shape to easily reflect the ultraviolet rays radiated from the ultraviolet ray sources 21, - - - toward the recording medium P.

Moreover, in the embodiments and the first to third modifications, the ultraviolet ray irradiating device 2 (102, 202, 302, 402, 502) is provided with the reflecting member 23 (323, 423). However, the present invention is not limited to this, and the system can be appropriately and optionally modified according to the irradiation strength of the ultraviolet rays of the ultraviolet ray irradiating device 2 or the like so as to be provided with the reflecting member 23 or no reflecting member.

<Modification of Ultraviolet Ray Source>

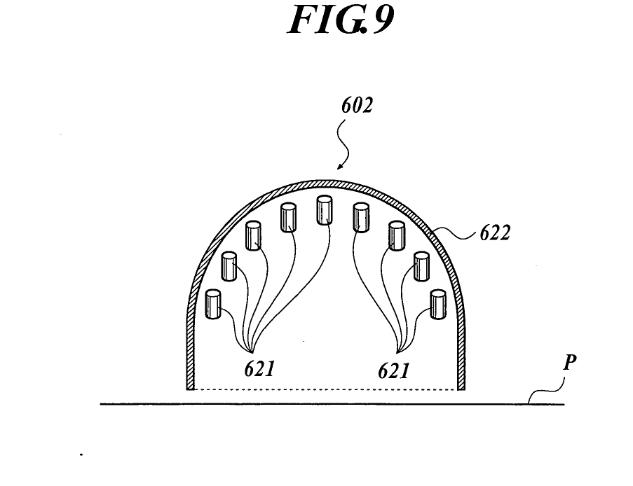

Hereinafter, a modification of the ultraviolet ray source will be described with reference to FIG. 9.

In this modification, functions and configuration of the modification other than those peculiar to the modification are the same as those of the first, second or third embodiment or the first, second or third modification. Therefore, the same constituent elements as those of the first, second or third embodiment or the first, second or third modification are indicated by the same referential numerals as those of the first, second or third embodiment or the first, second or third modification, and the description of the constituent elements is omitted.

FIG. 9 is a perspective side view schematically showing an ultraviolet ray irradiating device 602 having modified ultraviolet ray sources 621.

As shown in FIG. 9, the ultraviolet ray irradiating device 602 comprises a plurality of light emitting diodes as a plurality of ultraviolet ray sources 621.

In detail, the light emitting diodes are arranged in the ultraviolet ray irradiating device 602, while directing ultraviolet ray radiation ports of the light emitting diodes toward the side of the recording medium P, so as to have a convexity in a direction going away from the recording surface, that is, so as to be arranged in line in an arch shape in the longitudinal cross sectional view of the recording surface of the recording medium P. Therefore, the light emitting diodes can irradiate the recording medium P with the ultraviolet rays. In this modification, because no reflecting member is arranged on the inner surface of the cover member 622, the ultraviolet ray irradiating device 602 can be lightened in weight.

The present invention is not limited to the embodiments hereinbefore described, and various modifications and changes of design may be made to the embodiments without departing from the scope of the invention.

For example, the outline of the ultraviolet ray irradiating device 2 (102, 202, 302, 402, 502, 602) is not limited to the embodiments and the modifications. That is, any outline of the ultraviolet ray irradiating device can be allowed on condition that at least two ultraviolet ray sources 21, 21 adjacent to each other among the ultraviolet ray sources 21, - - - arranged adjacent to one another are placed so as to make distances from the two sources 21, 21 to the recording surface of the recording medium P be different from each other.

Further, in the embodiments, as an example, the reflecting plate made of aluminum or the cold mirror is shown as the reflecting member 23 (323, 423, 423). However, the present invention is not limited to this, and any member can be applied on condition that the member can reflect the ultraviolet rays toward the recording medium P.

Moreover, in the embodiments, the ink jet printer is provided with the four recording heads 1 or line heads 201 corresponding to the four colors of ink. However, the present invention is not limited to this, and the number of recording heads 1 or line heads 201 can be optionally set.

Further more, in the embodiments and modifications, the ultraviolet ray irradiating device 2 (102, 202, 302, 402, 502, 602) is provided with the three ultraviolet ray sources 21, 21, 21 or more. However, the present invention is not limited to this. That is, the number of ultraviolet ray sources 21, - - - can be appropriately and optionally modified according to the irradiation strength of the ultraviolet rays of the ultraviolet ray irradiating device 2 or the like, and it is sufficient that the ultraviolet ray irradiating device 2 (102, 202, 302, 402, 502, 602) is provided with at least the three ultraviolet ray sources 21, 21, 21 on condition that the three ultraviolet ray sources 21, 21, 21 are arranged in line so as to have a convexity in a direction going away from the recording surface of the recording medium P.

When each ultraviolet ray source 21 is made of a light source formed in a line shape, the ultraviolet ray irradiating device 2 (102, 202, 302, 402, 502, 602) and the recording heads 1 (line heads 201) are preferably arranged so as to make the both ends of the nozzle string of each recording head 1 be placed on the inside of the both ends of the ultraviolet ray sources 21, - - - in the longitudinal direction thereof. In detail, the distribution of the irradiation strength of the ultraviolet ray sources 21, - - - in the longitudinal direction thereof is not uniform, the distribution of the irradiation strength has a peak at the almost center of each ultraviolet ray source 21 in the longitudinal direction thereof, and the irradiation strength at a position is lowered as the position is far away from the center of the ultraviolet ray source 21. Therefore, because there is a probability in the image recording that the ink of the recording medium P passing almost just under the ends of the ultraviolet ray sources 21, - - - in the longitudinal direction thereof is not irradiated with the ultraviolet rays sufficient to cure the ink, the ultraviolet ray irradiating device 2 (102, 202, 302, 402, 502, 602) and the recording heads 1 (line heads 201) are arranged described above.

Further, the ends of the ultraviolet ray sources 21, - - - corresponding to the downstream side in the feeding direction (sub-scanning direction) of the recording medium P are preferably placed on the sufficiently downstream side of the ends of the nozzle strings corresponding to the downstream side. That is, for example, the ink has the cationic curing property, and the ink of a predetermined area A (hereinafter, named “predetermined area A”, and not shown) of the recording medium P is not irradiated in a scanning operation with the ultraviolet rays having the sufficient irradiation strength. However, in case of the configuration described above, when a predetermined area B (hereinafter, named “predetermined area B”, and not shown) of the recording medium P adjacent to the predetermined area A and placed on the upper stream side of the predetermined area A in the feeding direction is irradiated with the ultraviolet rays, portions of the ultraviolet ray sources 21, - - - on the downstream side of the feeding direction pass almost just over the predetermined area A, and the ink of the predetermined area A is irradiated with the ultraviolet rays radiated from the portions of the ultraviolet ray sources 21, - - - . Accordingly, the irradiation energy sufficient to cure the ink can be given to the ink of the predetermined area A.

The entire disclosure of Japanese Patent Application No. Tokugan 2002-336400 filed on Nov. 20, 2002 including specification, claims, drawings and summary are incorporated herein by reference in its entirety.

What is claimed is:

1. An ink jet printer, comprising:
a recording head for jetting ink to be cured by being irradiated with an ultraviolet ray from a nozzle to a recording medium; and
an ultraviolet ray irradiating device having a plurality of ultraviolet ray sources, the ultraviolet ray sources irradiating the ink jetted on the recording medium by the recording head with a plurality of ultraviolet rays,
wherein each of the ultraviolet ray sources radially radiates the ultraviolet ray from a center thereof in a radiation direction, and wherein at least two ultraviolet ray sources adjacent to each other among the ultraviolet ray sources arranged adjacent to one another are arranged so as to set distances from the two ultraviolet ray sources to a recording surface of the recording medium to be different from each other.

2. The ink jet printer of claim 1; wherein at least three ultraviolet ray sources among the ultraviolet ray sources are arranged in line so as to have a convexity in a direction going away from the recording surface.

3. The ink jet printer of claim 1; wherein the ultraviolet ray irradiating device further comprises a reflecting member for reflecting the ultraviolet rays radiated from the ultraviolet ray sources.

4. The ink jet printer of claim 3; wherein the reflecting member is a reflecting plate made of aluminum or a glass-formed plate having a surface on which a thin film of a metallic compound including aluminum is deposited.

5. The ink jet printer of claim 3; wherein at least three ultraviolet ray sources among the ultraviolet ray sources are arranged in line so as to have a convexity in a direction going away from the recording surface approach, and the reflecting member is shaped to be formed along the ultraviolet ray sources.

6. The ink jet printer of claim 1; wherein each ultraviolet ray source is a high pressure mercury lamp, a metal halide lamp, a hot cathode tube or a cold cathode tube.

7. The ink jet printer of claim 1; wherein the ink has a cationic curing property.

8. The ink jet printer of claim 1; wherein a recording type applied to the ink jet printer is a serial type or a line type.

9. An ink jet printer, comprising:
a recording head for jetting ink to be cured by being irradiated with an ultraviolet ray from a nozzle to a recording medium; and
an ultraviolet ray irradiating device having a plurality of ultraviolet ray sources, the ultraviolet ray sources irradiating the ink jetted on the recording medium by the recording head with a plurality of ultraviolet rays,
wherein each of the ultraviolet ray sources is a light emitting diode, and wherein at least two ultraviolet ray sources adjacent to each other among the ultraviolet ray sources arranged adjacent to one another are arranged so as to set distances from the two ultraviolet ray sources to a recording surface of the recording medium to be different from each other.

10. The ink jet printer of claim 9; wherein at least three ultraviolet ray sources among the ultraviolet ray sources are arranged in line so as to have a convexity in a direction going away from the recording surface.

11. The ink jet printer of claim 9; wherein the ink has a cationic curing property.

12. The ink jet printer of claim 9; wherein a recording type applied to the ink jet printer is a serial type or a line type.

13. An ultraviolet ray irradiating device which is arranged in an ink jet printer for jetting ink to be cured by being irradiated with an ultraviolet ray from a nozzle to a recording medium, the ultraviolet ray irradiating device comprising:
a plurality of ultraviolet ray sources for irradiating the ink jetted on the recording medium with a plurality of ultraviolet rays,
wherein each of the ultraviolet ray sources radially radiates the ultraviolet ray from a center thereof in a radiation direction, and wherein at least two ultraviolet ray sources adjacent to each other among the ultraviolet ray sources arranged adjacent to one another are arranged so as to set distances from the two ultraviolet ray sources to a recording surface of the recording medium to be different from each other.

14. The ultraviolet ray irradiating device of claim 13; wherein at least three ultraviolet ray sources among the ultraviolet ray sources are arranged in line so as to have a convexity in a direction going away from the recording surface.

15. The ultraviolet ray irradiating device of claim 13, further comprising a reflecting member for reflecting the ultraviolet rays radiated from the ultraviolet ray sources.

16. The ultraviolet ray irradiating device of claim 15; wherein the reflecting member is a reflecting plate made of aluminum or a glass-formed plate having a surface on which a thin film of a metallic compound including aluminum is deposited.

17. The ultraviolet ray irradiating device of claim 15; wherein at least three ultraviolet ray sources among the ultraviolet ray sources are arranged in line so as to have a convexity in a direction going away from the recording surface approach, and the reflecting member is shaped to be formed along the ultraviolet ray sources.

18. The ultraviolet ray irradiating device of claim 13; wherein each ultraviolet ray source is a high pressure mercury lamp, a metal halide lamp, a hot cathode tube or a cold cathode tube.

19. An ultraviolet ray irradiating device which is arranged in an ink jet printer for jetting ink to be cured by being irradiated with an ultraviolet ray from a nozzle to a recording medium, the ultraviolet ray irradiating device comprising:
a plurality of ultraviolet ray sources for irradiating the ink jetted on the recording medium with a plurality of ultraviolet rays,
wherein each of the ultraviolet ray sources is a light emitting diode, and wherein at least two ultraviolet ray sources adjacent to each other among the ultraviolet ray sources arranged adjacent to one another are arranged so as to set distances from the two ultraviolet ray sources to a recording surface of the recording medium to be different from each other.

20. The ultraviolet ray irradiating device of claim 19; wherein at least three ultraviolet ray sources among the ultraviolet ray sources are arranged in line so as to have a convexity in a direction going away from the recording surface.
